(19) United States
(12) Patent Application Publication
(10) Pub. No.: US 2017/0278308 A1
(43) Pub. Date: Sep. 28, 2017

(54) IMAGE MODIFICATION AND ENHANCEMENT USING 3-DIMENSIONAL OBJECT MODEL BASED RECOGNITION

(71) Applicant: INTEL CORPORATION, Santa Clara, CA (US)

(72) Inventors: Amit Bleiweiss, Yad Binyamin (IL); Dagan Eshar, Tel Aviv-Yafo (IL)

(73) Assignee: INTEL CORPORATION, Santa Clara, CA (US)

(21) Appl. No.: 15/077,976

(22) Filed: Mar. 23, 2016

(51) Int. Cl. G06T 19/20; G06K 9/62; G06T 19/00

(52) U.S. Cl. CPC G06T 19/20; G06T 19/003; G06K 9/6269; G06T 2219/2008; G06T 2219/2021; H04N 13/0282

(57) ABSTRACT

Techniques are provided for image modification and enhancement based on recognition of objects in a scene image. An example system may include an image rendering circuit to render a number of image variations of an object based on a 3D model of the object. The 3D model may be generated by a computer aided design tool or a 3D scanning tool. The system may also include a classifier generation circuit to generate an object recognition classifier based on the rendered image variations. The system may further include an object recognition circuit to recognize the object from an image of a scene containing the object. The recognition is performed by the generated object recognition classifier. The system may still further include an image modification circuit to create a mask to segment the recognized object from the image of the scene and modify the masked segment of the image of the scene.

### BACKGROUND

Cameras which are integrated into mobile devices continue to improve in quality. Along with this improvement, capabilities for enhanced photography are becoming an increasingly common requirement for consumers of these products. The term “enhanced photography,” as used herein, refers to the process of modifying or improving an image or video using additional data and/or user input. The fact that photographs may contain a virtually unlimited number of objects, however, presents a challenge to the provision of enhanced photography capabilities, since an increased level of user input and skill may be required for image modification. Manual editing or manipulation of images by the user, with conventional systems, is often difficult and typically requires technical skills or professional experience, as well as specialized tools which can be expensive.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts.

FIG. 1 is a top level block diagram of an application of a system for image manipulation, in accordance with certain of the embodiments disclosed herein.

FIG. 2 is a more detailed block diagram of a system for image manipulation, configured in accordance with certain of the embodiments disclosed herein.

FIG. 3 is a block diagram of an image rendering circuit, configured in accordance with certain of the embodiments disclosed herein.

FIG. 4 is a block diagram of an image modification circuit, configured in accordance with certain of the embodiments disclosed herein.

FIGS. 5(a) through 5(e) illustrate object replacement, in accordance with certain of the embodiments disclosed herein.

FIG. 6 is a flowchart illustrating a methodology for image manipulation, in accordance with certain of the embodiments disclosed herein.

FIG. 7 is a block diagram graphically illustrating the methodology depicted in FIG. 6, in accordance with an example embodiment.

FIG. 8 is a block diagram schematically illustrating a system platform to manipulate images, configured in accordance with certain of the embodiments disclosed herein.

Although the following Detailed Description will proceed with reference being made to illustrative embodiments, many alternatives, modifications, and variations thereof will be apparent to those skilled in the art.

### DETAILED DESCRIPTION

Generally, this disclosure provides techniques for enhanced photography which may simplify and improve the process of image or video manipulation by a user of the system. The images may be captured by a camera that is integrated in a mobile platform, such as a tablet or smartphone. The camera may be configured to provide 3D images or video. The manipulation may include enhancement or modification of detected objects within the imaged scene. The detection and recognition of these objects, and their location within the scene, provides additional information about the objects and allows for relatively precise segmentation of the objects, thus enabling more sophisticated manipulations. For example, selected objects may be rotated or re-shaped, illumination and other visual effects may be varied, and objects may be replaced with other objects. Additionally, techniques are disclosed for the generation of a classifier to detect and recognize those objects from the imaged scene. For example, a 3D model of the object may serve as the basis from which a desired number of image variations of the object are rendered and used to train a classifier. The rendered images may include varying backgrounds, adjustment of object pose, and application of differing illumination and other visual effects, to provide a relatively wide variety of images of the object for classifier generation/training. The techniques described herein, for image modification and enhancement, provide generally improved results over conventional image processing techniques that require specialized tools and training. As will be further appreciated in light of this disclosure, the techniques provided herein can be implemented in hardware or software or a combination thereof, and may be adapted into any number of applications where image manipulation is desired.

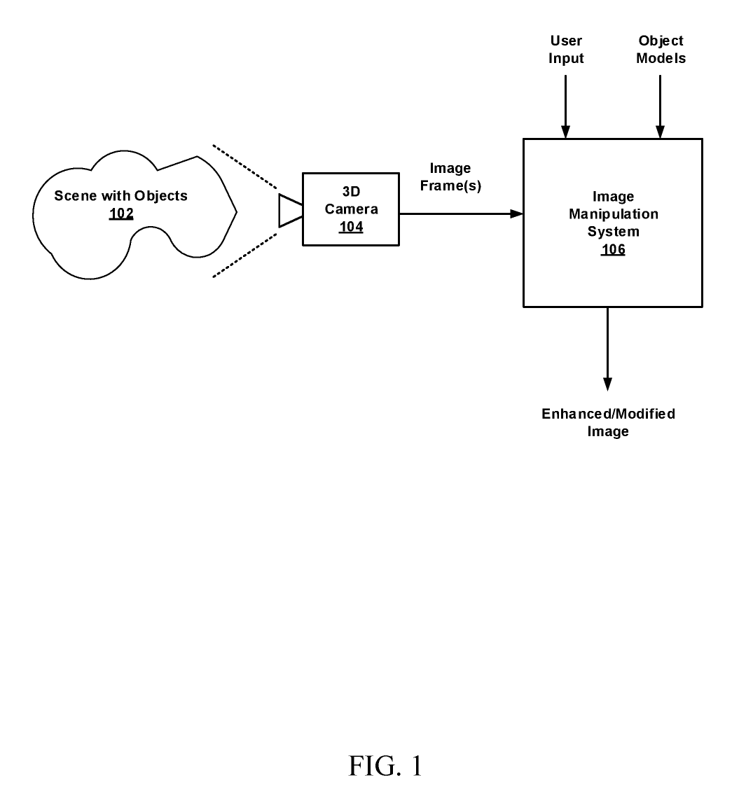

FIG. 1 is a top level block diagram 100 of an application of a system for image manipulation, in accordance with certain of the embodiments disclosed herein. The system is shown to include a 3D camera 104 and an image manipulation system 106. The 3D camera 104 is configured to capture image frames or video of a scene 102 that includes some number of objects. For example, the scene could be a room and the objects could be items of furniture, or the scene could be an aisle in a store and the objects could be items for sale on the shelves. Image manipulation system 106 may be configured to modify or enhance the images provided by camera 104, based on user input and further based on 3D models of the objects that may potentially appear in the scene 102, as will be described in greater detail below. In some embodiments, the 3D models of the objects may be provided as computer aided design (CAD) files, for example from the manufacturer of the object. In some embodiments, they may be generated from 3D scans of the object from multiple viewpoints and the scans may be obtained from the 3D camera 104 or other sources.

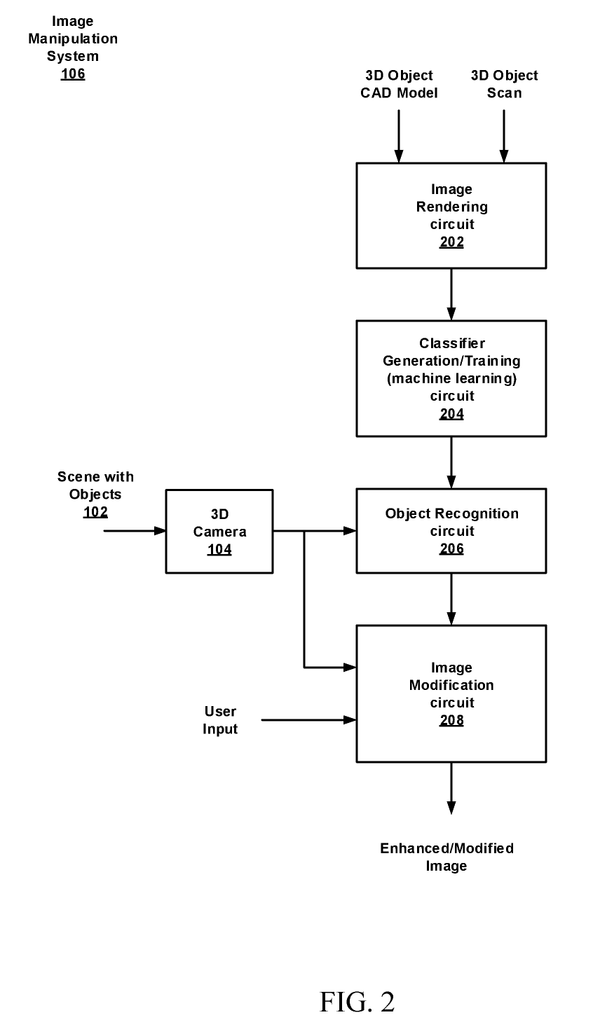

FIG. 2 is a more detailed block diagram of the system 106 for image manipulation, configured in accordance with certain of the embodiments disclosed herein. The image manipulation system 106 is shown to include an image rendering circuit 202, a classifier generation/training circuit 204, an object recognition circuit 206 and an image modification circuit 208, the operations of which will be explained in greater detail below.

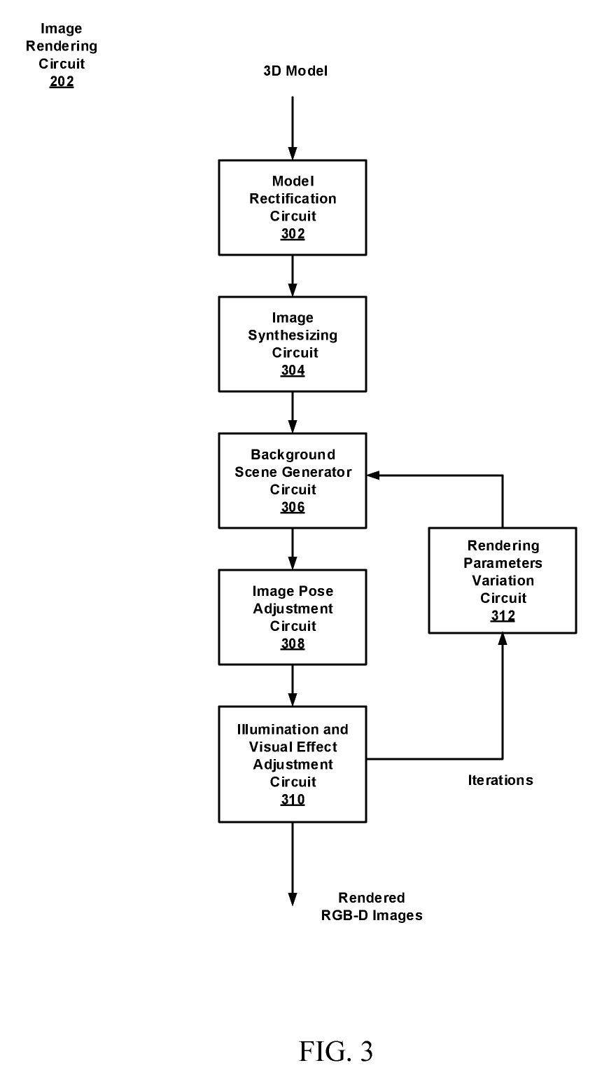

The image rendering circuit 202 may be configured to render a desired number of image variations of an object based on a 3D model of the object. Each rendered image may include variations of a background scene, the pose of the object, and/or illumination and visual effects, as will be described in greater detail below in connection with FIG. 3.

The classifier generation/training circuit 204 may be configured to generate an object recognition classifier based on any desired number of the rendered image variations provided by image rendering circuit 202. The object recognition classifier may be trained on the image variations using any known techniques in light of the present disclosure. In some embodiments, the classifier generation/training circuit 204 may be a machine learning system that is configured to implement a Convolutional Neural Network (CNN), a Random Forest Classifier or a Support Vector Machine (SVM). In some embodiments, the image rendering circuit 202 and/or the classifier generation/training circuit 204 (machine learning system) may be hosted on a local system or on a cloud based system. For example a user may upload a 3D CAD model to a cloud based system where rendering and/or classifier training is performed.

The object recognition circuit 206 may be configured to recognize the object from an image of a scene containing the object, based on the generated object recognition classifier. Because the classifier was generated from a variety of image renderings, the object recognition circuit 206 may thus be configured to recognize the object even though it appears in a new image (the scene 102) under potentially different visual conditions and in different poses against different backgrounds.

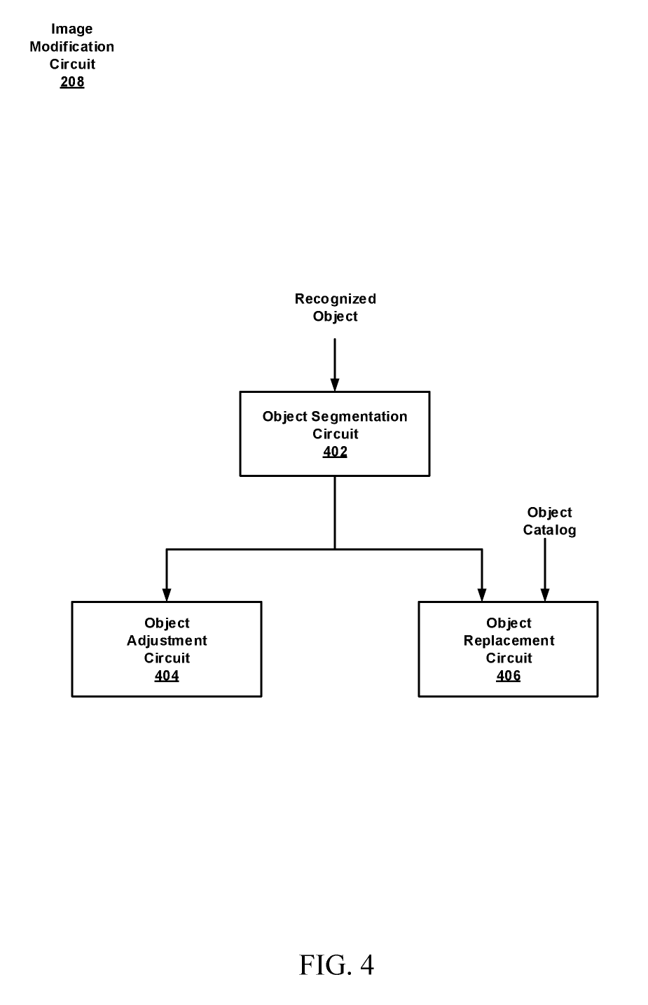

The image modification circuit 208 may be configured to create a mask to segment the recognized object from the image of the scene and modify the masked segment of the image of the scene based on user requests or other input, as will be described in greater detail below in connection with FIG. 4.

FIG. 3 is a more detailed block diagram of the image rendering circuit 202, configured in accordance with certain of the embodiments disclosed herein. The image rendering circuit 202 is shown to include a model rectification circuit 302, an image synthesizing circuit 304, a background scene generator circuit 306, an image pose adjustment circuit 308, an illumination and visual effect adjustment circuit 310 and a rendering parameters variation circuit 312, the operations of which will be explained in greater detail below. Of course, the order of the circuits as illustrated represents one possible example and other variations are possible, for example pose adjustment could be performed before background scene generation.

The image rendering circuit 202 generates image variations of an object based on a 3D model of the object. Such 3D models generally define or describe the 3D surface of the object, either through a mathematical representation or through a collection of points in a 3D coordinate space that may be connected by geometric shapes such as polygons. In some embodiments, the model may be provided by the manufacturer of the object. The model may be generated by a CAD tool, for example as part of the process of designing the object. Alternatively, the model may be created by a 3D scanning tool configured to scan a physical sample of the object. In yet another alternative, the model may be created by a designer using a 3D sculpting tool, or by any other known techniques in light of the present disclosure

The model rectification circuit 302 may be configured to scale the 3D model of the object to a normalized size and to translate the model to an origin point of a 3D coordinate system, as an optional initialization operation. This may be desirable to compensate for the fact that different 3D model generation techniques may produce models of arbitrary size, orientation and/or location relative to a given coordinate system. Rectification may thus ensure that all models are on a similar scale and share a common coordinate system, which may therefore facilitate the implementation and performance of subsequent processing modules and circuits described below.

The image synthesizing circuit 304 may be configured to synthesize a 3D image (e.g., a color image and depth image) of the object based on the 3D model of the object, using known techniques in light of the present disclosure. A relatively large number of 3D image variations may subsequently be rendered based on the synthesized 3D image of the object generated by this circuit. The number of variations may be in the range of hundreds, thousands or more. Any combination of the operations, performed by the components described below, may be applied to create each rendering variation.

The background scene generator circuit 306 may be configured to generate a background scene for each of the rendered image variations. Each rendered variation may include a potentially unique background scene, although it is also possible to re-use background scenes if desired. In some embodiments, the background scene generator may randomly select a background scene from a database of background scenes. In some embodiments, the background scene may be a 2D planar image located behind the object. In some embodiments, the background scene may be a more complex 3D constructed model. For example, there could be a table located inside a house, where the table is the object of interest and the floor and walls of the house serve as the background scene.

The image pose adjustment circuit 308 may be configured to adjust the pose (e.g., orientation and/or translation) of the object for each of the rendered image variations. Additionally, for example in the case of non-rigid objects, the image pose adjustment circuit may further adjust the pose of regions of the object, where the regions are associated with components or subcomponents of the object that may be free to move relative to each other. Renderings may be generated that include all possible (or practical) permutations and combinations of poses of the different components or sub-components of the object.

The illumination and visual effect adjustment circuit 310 may be configured to adjust illumination of the object and/or of the generated background for each of the rendered image variations. The illumination may be adjusted or varied, for example from brighter to darker or vice versa, and, in some embodiments, the contrast of the object may also be varied. As a further example, some parts of the image may be shadowed while other parts are highlighted, or some parts of the object may be made to appear shiny while other parts are dulled. As yet a further example, the color of the lighting may be varied.

The illumination and visual effect adjustment circuit 310 may further be configured to adjust visual effects of the object and/or the background for each of the rendered image variations based on an application of simulated camera parameters. The simulated camera parameters may include, for example, lens focal length and lens aperture. Changing the lens focal length can change the field of view, for example from a wide angle effect to a telephoto effect. Changing the lens aperture can change the depth of field of the image (i.e., the range of depths at which the image and background is in focus).

The rendering parameters variation circuit 312 may be configured to generate parameters to control or select the desired effects for each iteration or variation. The parameters may control, for example, the pose adjustment and illumination and visual effects for the object and/or the background of the image. The selection of the parameters may be determined by an operator or user of the system, or may be pre-determined based on the nature of the objects. The selection of the parameters may also be determined based on the type of classifier that is to be generated or the desired performance characteristics of the classifier.

FIG. 4 is a more detailed block diagram of the image modification circuit 208, configured in accordance with certain of the embodiments disclosed herein. The image modification circuit 208 may be configured to segment the recognized object from the image of the scene for modification based on user requests or other input. The image modification circuit 208 is shown to include an object segmentation circuit 402, an object adjustment circuit 404 and an object replacement circuit 406, the operations of which will be explained in greater detail below.

The object segmentation circuit 402 may be configured to segment the recognized object from the image of the scene for modification. In some embodiments a mask (e.g., a bitmask) may be generated to define the region of the image scene that is associated with the object to be segmented. The region may be defined in terms of image pixels or any other suitable measure of the object or the boundary of the object. For example, the mask may include the pixels of the recognized object.

The object adjustment circuit 404 may be configured to adjust or otherwise modify the segmented object. Such adjustments may include changing the illumination of the masked segment, rotating the segmented object or reshaping the segment object. The desired adjustments may be specified by a user of the system. The application of these changes may be limited to the masked pixels.

The object replacement circuit 406 may be configured to enable replacement of the segmented object with a different object, which may be specified by the user. For example, the user may select a replacement object from a catalog of available objects. The replacement process may thus proceed with the substitution of pixels of the segment object, within the masked region, with pixels of the replacement object.

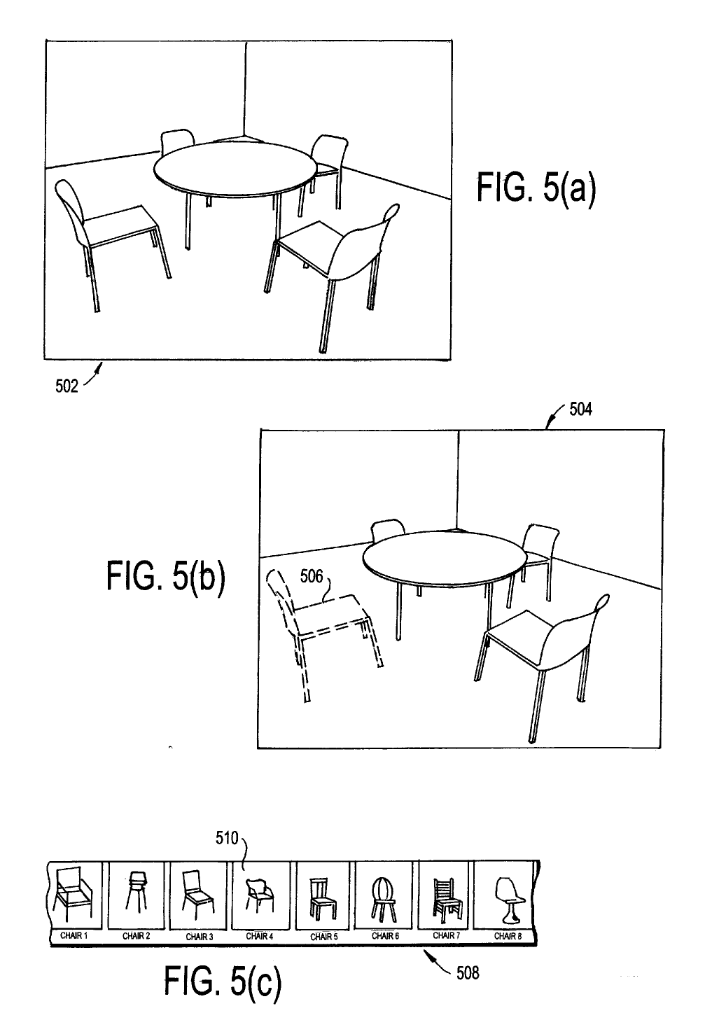

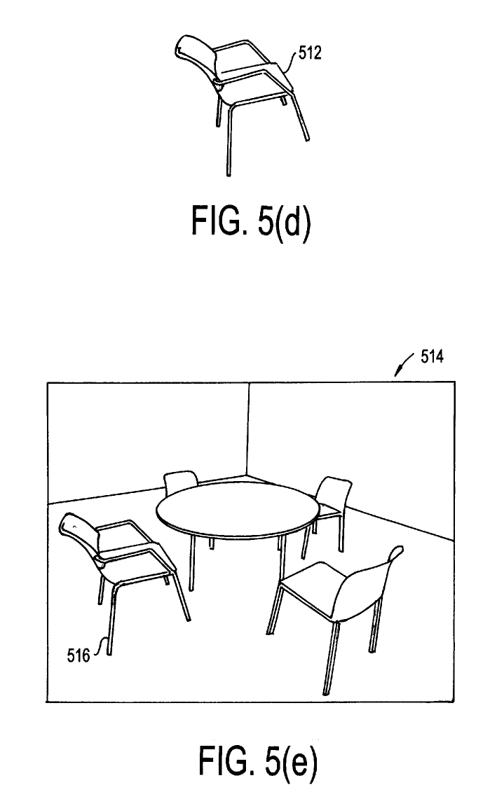

FIGS. 5(a) through 5(e) further illustrate object replacement, in accordance with certain of the embodiments disclosed herein. A video of a scene 502 is recorded by a user of a tablet or smartphone with a 3D camera and shown in FIG. 5(a). Next, in FIG. 5(b), an object, in this case one of the chairs 506, is recognized from one or more of the video frames and segmented from the scene 504. The recognition may be based on a classifier that was generated from a model of the chair 506 or from previously scanned images of the chair. In FIG. 5(c), the user selects a replacement object 510, in this case a new chair, for example from a catalog of furniture 508. The image of the replacement chair 510 may be resized, rotated, re-illuminated and or otherwise transformed to appear as chair 512 in FIG. 5(d). The transformation will depend on the location and orientation of the original chair 506 and may be configured to match the masked region. In FIG. 5(e), the new transformed chair 516 is rendered at the same size, location and orientation as the original chair 506 and inserted into the original scene which now appears as scene 514, thus affecting a swap out of the original chair for the new chair.

The segmentation mask of the object to be replaced may differ from that of the replacement object, due to differences in shape. As such, the background image may need to be modified after the insertion of the new object due to “holes” in the background (e.g., pixels that were not covered by the replacement object). In some embodiments, known background filling techniques, in light of the present disclosure, may be employed to paint or in-fill these holes.

As another example application, images of products in a retail store may be updated in a relatively automatic fashion to evaluate the reactions of customers to a store redesign in a more efficient way. In this example, the current items in a store would be scanned with a 3D camera to create models that can be used for training a classifier to recognize those items. Then, photographs or videos are taken of all the store shelves with the current inventory of items. The current items are recognized by the classifier, segmented, and replaced with new items. The modified scenes with the new items may be presented to customers for review and feedback, or they may be used to generate a virtual reality tour of the newly outfitted store.

Methodology

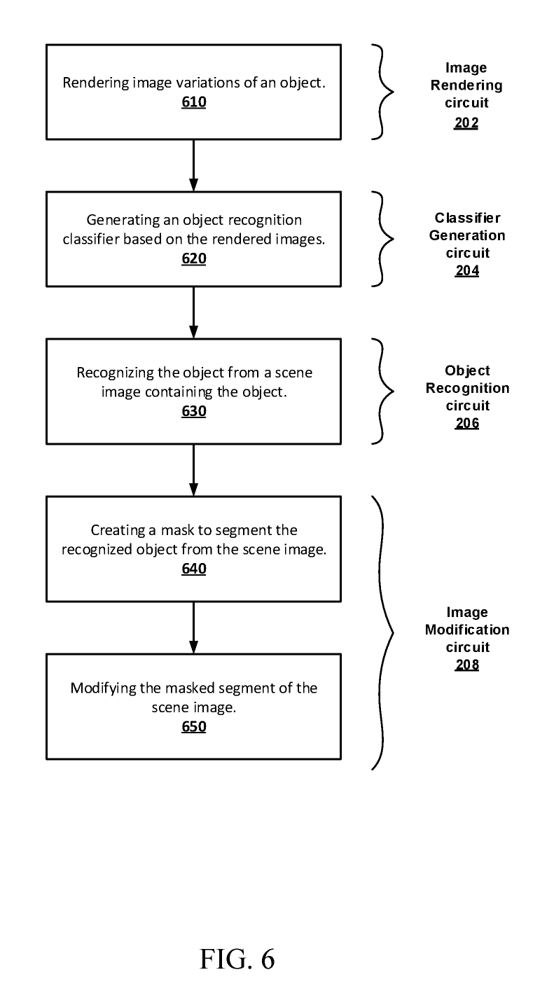

FIG. 6 is a flowchart illustrating an example method 600 for image modification and enhancement based on recognition of objects in an image of a scene, in accordance with an embodiment of the present disclosure. As can be seen, example method 600 includes a number of phases and sub-processes, the sequence of which may vary from one embodiment to another. However, when considered in the aggregate, these phases and sub-processes form a process for temporally coherent disparity calculation in accordance with certain of the embodiments disclosed herein. These embodiments can be implemented, for example using the system architecture illustrated in FIG. 2, as described above. However other system architectures can be used in other embodiments, as will be apparent in light of this disclosure. To this end, the correlation of the various functions shown in FIG. 6 to the specific components illustrated in FIG. 2 is not intended to imply any structural and/or use limitations. Rather other embodiments may include, for example, varying degrees of integration wherein multiple functionalities are effectively performed by one system. For example, in an alternative embodiment a single module can be used to perform all of the functions of method 600. Thus other embodiments may have fewer or more modules and/or sub-modules depending on the granularity of implementation. Numerous variations and alternative configurations will be apparent in light of this disclosure.

As illustrated in FIG. 6, in one embodiment, method 600 for image modification and enhancement commences, at operation 610, by rendering a relatively large number of image variations of an object based on a 3D model of the object. In some embodiments, each image variation may include one or more of a varied background scene, an adjusted pose of the object, adjusted illumination and adjusted visual effects based on simulated camera parameters.

Next, at operation 620, an object recognition classifier is generated based on the rendered images. In some embodiments, the object recognition classifier may be generated or trained by a machine learning system, for example based on a Convolutional Neural Network (CNN), a Random Forest Classifier or a Support Vector Machine (SVM).

At operation 630, the generated object recognition classifier is used to recognize the object from an image of a scene that includes the object. The scene image may be captured by a 3D camera. At operation 640, a mask is created to segment the recognized object from the image of the scene. The mask, or bitmask, may be configured to segment a region or grouping of pixels of the image scene which correspond to the recognized object so that, at operation 650, the masked segment of the scene image may be manipulated (e.g., modified or enhanced). In some embodiments, manipulation may include replacing the object with another object. In some embodiments, manipulation may include adjusting the illumination of the masked segment, rotating the segmented object, and/or reshaping the segmented object.

Of course, in some embodiments, additional operations may be performed, as previously described in connection with the system. These additional operations may include, for example, allowing a user of the system to select a replacement object from a catalog of available objects. Further additional operations may include, for example, generating the 3D model of the object by employing a computer aided design (CAD) tool or a 3D scanning tool.

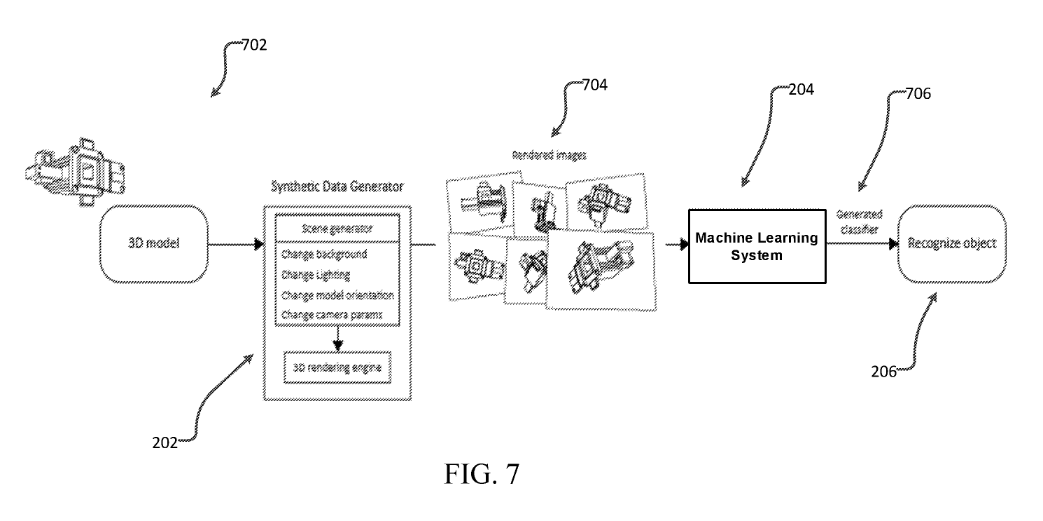

FIG. 7 is a block diagram graphically illustrating the methodology depicted in FIG. 6, in accordance with an example embodiment. A 3D model of an example object 702 is shown being provided to the image rendering circuit 202, as described in operation 610 above. In some embodiments, varying 3D scenes may be rendered, for example by module 202, by changing the background, lighting, modeled object orientation, and/or simulated camera parameters such as depth of field and angle of viewing field, as described above. A number of rendered images 704 of the object are shown. Although 6 examples are shown for simplicity, in practice a larger number of renderings may be generated, perhaps on the order of thousands to millions of renderings. These rendered images 704 may be stored in a database and/or provided directly to the classifier generation circuit (machine learning system) 204, as described in operation 620 above. Classifier generation circuit (machine learning system) 204 may be configured to generate a recognition classifier 706 for the modeled object 702, for example based on training using the rendered images 704, or a subset thereof. The generated classifier 706 may then be employed to recognize instances of the object 702 in a variety of real world images or scenes.

Example System

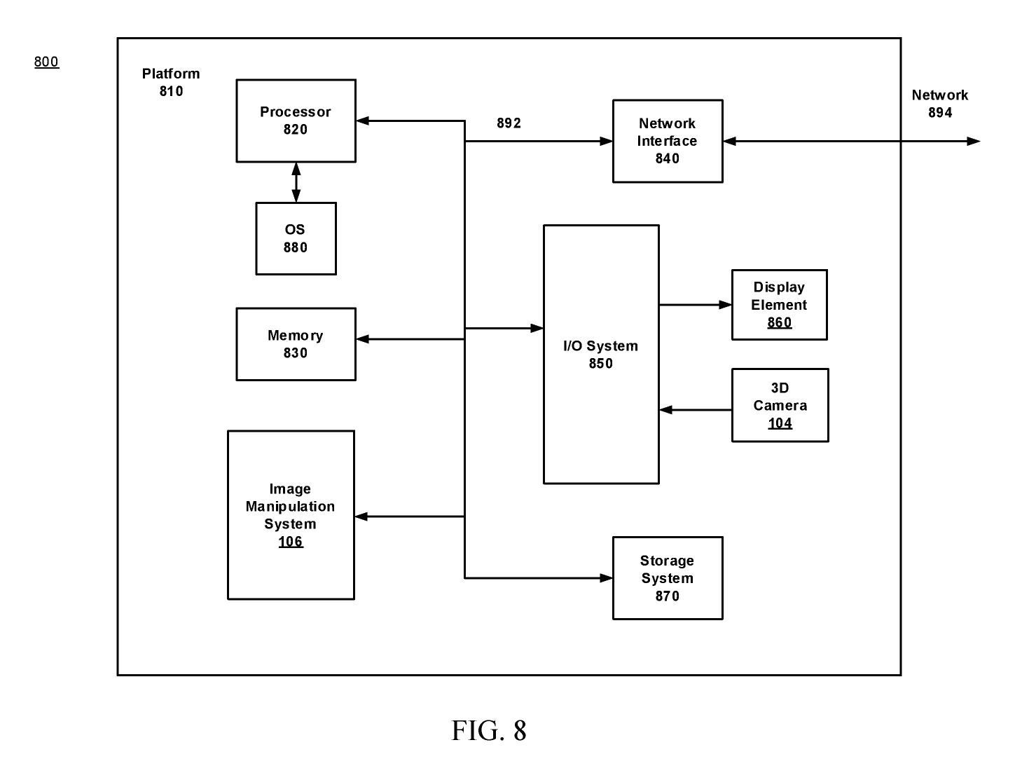

FIG. 8 illustrates an example system 800 that may be configured to provide image modification and enhancement based on recognition of objects in an image of a scene, as described herein. In some embodiments, system 800 comprises a platform 810 which may host, or otherwise be incorporated into a personal computer, workstation, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), and so forth. Any combination of different devices may be used in certain embodiments.

In some embodiments, platform 810 may comprise any combination of a processor 820, a memory 830, an image manipulation system 106, a 3D camera 104, a network interface 840, an input/output (I/O) system 850, a display element 860, and a storage system 870. As can be further seen, a bus and/or interconnect 892 is also provided to allow for communication between the various components listed above and/or other components not shown. Platform 810 can be coupled to a network 894 through network interface 840 to allow for communications with other computing devices, platforms or resources. Other componentry and functionality not reflected in the block diagram of FIG. 8 will be apparent in light of this disclosure, and it will be appreciated that other embodiments are not limited to any particular hardware configuration.

Processor 820 can be any suitable processor, and may include one or more coprocessors or controllers, such as an audio processor or a graphics processing unit, to assist in control and processing operations associated with system 800. In some embodiments, the processor 820 may be implemented as any number of processor cores. The processor (or processor cores) may be any type or combination of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 820 may be implemented as a complex instruction set computer (CISC) or a reduced instruction set computer (RISC) processor. In some embodiments, processor 820 may be configured as an x86 instruction set compatible processor.

Memory 830 can be implemented using any suitable type of digital storage including, for example, flash memory and/or random access memory (RAM). In some embodiments, the memory 830 may include various layers of memory hierarchy and/or memory caches as are known to those of skill in the art. Memory 830 may be implemented as a volatile memory device such as, but not limited to, a RAM, dynamic RAM (DRAM), or static RAM (SRAM) device. Storage system 870 may be implemented as a non-volatile storage device such as, but not limited to, one or more of a hard disk drive (HDD), a solid state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 870 may comprise technology to increase the storage performance enhanced protection for valuable digital media when multiple hard drives are included.

Processor 820 may be configured to execute an Operating System (OS) 880 which may comprise any suitable operating system, such as Google Android (Google Inc., Mountain View, Calif.), Microsoft Windows (Microsoft Corp., Redmond, Wash.), Linux, or Apple OS X (Apple Inc., Cupertino, Calif.) and/or various real-time operating systems. As will be appreciated in light of this disclosure, the techniques provided herein can be implemented without regard to the particular operating system provided in conjunction with system 800, and therefore may also be implemented using any suitable existing or subsequently-developed platform.

Network interface module 840 can be any appropriate network chip or chipset which allows for wired and/or wireless connection between other components of computer system 800 and/or network 894, thereby enabling system 800 to communicate with other local and/or remote computing systems, servers, and/or resources. Wired communication may conform to existing (or yet to developed) standards, such as, for example, Ethernet. Wireless communication may conform to existing (or yet to developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 850 may be configured to interface between various I/O devices and other components of computer system 800. I/O devices may include, but not be limited to, a display element 860, a 3D camera 104, and other devices not shown such as a keyboard, mouse, speaker, microphone, etc.

I/O system 850 may include a graphics subsystem configured to perform processing of images for display element 860. Graphics subsystem may be a graphics processing unit or a visual processing unit (VPU), for example. An analog or digital interface may be used to communicatively couple graphics subsystem and display element 860. For example, the interface may be any of a high definition multimedia interface (HDMI), DisplayPort, wireless HDMI, and/or any other suitable interface using wireless high definition compliant techniques. In some embodiment, the graphics subsystem could be integrated into processor 820 or any chipset of platform 810. In some embodiments, display element 860 may comprise any television type monitor or display, including liquid crystal displays (LCDs) and light emitting diode displays (LEDs). Display element 860 may comprise, for example, a computer display screen, touchscreen display, video monitor, television-like device, and/or a television. Display element 860 may be digital and/or analog. Under the control of the OS 880 (or one or more software applications), platform 810 may display processed images on display element 860. The images may be provided by image manipulation system 106, 3D camera 104 or other sources. Camera 104 may be configured to provide color (RGB) images and depth images.

It will be appreciated that in some embodiments, the various components of the system 800 may be combined or integrated in a system-on-a-chip (SoC) architecture. In some embodiments, the components may be hardware components, firmware components, software components or any suitable combination of hardware, firmware or software.

Image manipulation system 106 is configured to provide image modification and enhancement based on recognition of objects in an image of a scene. Image manipulation system 106 may include any or all of the components illustrated in FIG. 2 and described above. Image manipulation system 106 can be implemented or otherwise used in conjunction with a variety of suitable software and/or hardware that is coupled to or that otherwise forms a part of system 800. Image manipulation system 106 can additionally or alternatively be implemented or otherwise used in conjunction with user I/O devices that are capable of providing information to, and receiving information and commands from, a user. These I/O devices may include display element 860, a textual input device such as a keyboard, and a pointer-based input device such as a mouse. Other input/output devices that may be used in other embodiments include a touchscreen, a touchpad, a speaker, and/or a microphone. Still other input/output devices can be used in other embodiments.

In some embodiments image manipulation system 106 may be installed local to system 800, as shown in the example embodiment of FIG. 8. Alternatively, system 800 can be implemented in a client-server arrangement (or local and cloud based arrangement) wherein at least some functionality associated with image manipulation system 106 is provided to system 800 using an applet, such as a JavaScript applet, or other downloadable module. Such a remotely accessible module or sub-module can be provisioned in real-time in response to a request from a client computing system for access to a given server having resources that are of interest to the user of the client computing system. In such embodiments the server can be local to network 894 or remotely coupled to network 894 by one or more other networks and/or communication channels. In some cases access to resources on a given network or computing system may require credentials such as usernames, passwords, and/or compliance with any other suitable security mechanism.

In various embodiments, system 800 may be implemented as a wireless system, a wired system, or a combination of both. When implemented as a wireless system, system 800 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, system 800 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example in one embodiment at least one non-transitory computer readable storage medium has instructions encoded thereon that, when executed by one or more processors, cause one or more of the methodologies for image manipulation, disclosed herein, to be implemented. The instructions can be encoded using a suitable programming language, such as C, C++, object oriented C, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, image manipulation system 106 may operate by leveraging processing resources provided by a remote computer system accessible via network 894. In other embodiments the functionalities disclosed herein can be incorporated into other software applications, such as image management applications. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus in other embodiments system 800 may comprise additional, fewer, or alternative subcomponents as compared to those included in the example embodiment of FIG. 8.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Other embodiments may be implemented as software executed by a programmable control device. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a method for image manipulation. The method comprises: rendering a plurality of image variations of an object based on a 3-Dimensional (3D) model of the object; generating an object recognition classifier based on the rendered image variations; recognizing the object from an image of a scene containing the object, the recognizing employing the generated object recognition classifier; creating a mask to segment the recognized object from the image of the scene; and modifying the masked segment of the image of the scene.

Example 2 includes the subject matter of Example 1, wherein the rendering further comprises at least one of, for each of the variations: generating a background scene; adjusting an orientation and translation of the object; adjusting illumination of the object and of the background scene; and adjusting visual effects of the object and of the background scene based on application of simulated camera parameters.

Example 3 includes the subject matter of Examples 1 or 2, wherein the modifying further comprises replacing the segmented object with a second object.

Example 4 includes the subject matter of any of Examples 1-3, wherein the second object is selected by a user from a catalog of objects.

Example 5 includes the subject matter of any of Examples 1-4, wherein the modifying further comprises at least one of adjusting illumination of the masked segment, rotating the segmented object, and reshaping the segmented object.

Example 6 includes the subject matter of any of Examples 1-5, wherein the object recognition classifier is generated by a processor executed machine learning system based on a Convolutional Neural Network (CNN), a Random Forest Classifier or a Support Vector Machine (SVM).

Example 7 includes the subject matter of any of Examples 1-6, wherein the image of the scene is a 3D image.

Example 8 includes the subject matter of any of Examples 1-7, further comprising generating the 3D model of the object by employing a computer aided design (CAD) tool or a 3D scanning tool.

Example 9 is a system for image manipulation. The system comprises: an image rendering circuit to render a plurality of image variations of an object based on a 3-Dimensional (3D) model of the object; a classifier generation circuit to generate an object recognition classifier based on the rendered image variations; an object recognition circuit to recognize the object from an image of a scene containing the object, based on the generated object recognition classifier; and an image modification circuit to create a mask to segment the recognized object from the image of the scene and modify the masked segment of the image of the scene.

Example 10 includes the subject matter of Example 9, wherein the image rendering circuit further comprises at least one of: a background scene generator circuit to generate a background scene for each of the rendered image variations; an image pose adjustment circuit to adjust an orientation and translation of the object for each of the rendered image variations; and an illumination and visual effect adjustment circuit to adjust illumination of the object and of the background scene for each of the rendered image variations, and to further adjust visual effects of the object and of the background scene for each of the rendered image variations based on application of simulated camera parameters.

Example 11 includes the subject matter of Examples 9 or 10, wherein the image modification circuit is further to replace the segmented object with a second object.

Example 12 includes the subject matter of any of Examples 9-11, wherein the second object is selected by a user from a catalog of objects.

Example 13 includes the subject matter of any of Examples 9-12, wherein the image modification circuit is further to perform at least one of adjusting illumination of the masked segment, rotating the segmented object, and reshaping the segmented object.

Example 14 includes the subject matter of any of Examples 9-13, wherein the classifier generation circuit further comprises a machine learning system based on a Convolutional Neural Network (CNN), a Random Forest Classifier or a Support Vector Machine (SVM).

Example 15 includes the subject matter of any of Examples 9-14, wherein the image of the scene is a 3D image.

Example 16 includes the subject matter of any of Examples 9-15, wherein the 3D model of the object is generated by a computer aided design (CAD) tool or a 3D scanning tool.

Example 17 is at least one non-transitory computer readable storage medium having instructions encoded thereon that, when executed by one or more processors, result in the following operations for image manipulation. The operations comprise: rendering a plurality of image variations of an object based on a 3-Dimensional (3D) model of the object; generating an object recognition classifier based on the rendered image variations; recognizing the object from an image of a scene containing the object, the recognizing employing the generated object recognition classifier; creating a mask to segment the recognized object from the image of the scene; and modifying the masked segment of the image of the scene.

Example 18 includes the subject matter of Example 17, wherein the rendering further comprises at least one of, for each of the variations: generating a background scene; adjusting an orientation and translation of the object; adjusting illumination of the object and of the background scene; and adjusting visual effects of the object and of the background scene based on application of simulated camera parameters.

Example 19 includes the subject matter of Examples 17 or 18, wherein the modifying further comprises replacing the segmented object with a second object.

Example 20 includes the subject matter of any of Examples 17-19, wherein the second object is selected by a user from a catalog of objects.

Example 21 includes the subject matter of any of Examples 17-20, wherein the modifying further comprises at least one of adjusting illumination of the masked segment, rotating the segmented object, and reshaping the segmented object.

Example 22 includes the subject matter of any of Examples 17-21, wherein the object recognition classifier is generated by a processor executed machine learning system based on a Convolutional Neural Network (CNN), a Random Forest Classifier or a Support Vector Machine (SVM).

Example 23 includes the subject matter of any of Examples 17-22, wherein the image of the scene is a 3D image.

Example 24 includes the subject matter of any of Examples 17-23, further comprising generating the 3D model of the object by employing a computer aided design (CAD) tool or a 3D scanning tool.

Example 25 is a system for image manipulation. The system comprises: means for rendering a plurality of image variations of an object based on a 3-Dimensional (3D) model of the object; means for generating an object recognition classifier based on the rendered image variations; means for recognizing the object from an image of a scene containing the object, the recognizing employing the generated object recognition classifier; means for creating a mask to segment the recognized object from the image of the scene; and means for modifying the masked segment of the image of the scene.

Example 26 includes the subject matter of Example 25, wherein the rendering further comprises at least one of, for each of the variations: means for generating a background scene; means for adjusting an orientation and translation of the object; means for adjusting illumination of the object and of the background scene; and means for adjusting visual effects of the object and of the background scene based on application of simulated camera parameters.

Example 27 includes the subject matter of Examples 25 or 26, wherein the modifying further comprises means for replacing the segmented object with a second object.

Example 28 includes the subject matter of any of Examples 25-27, wherein the second object is selected by a user from a catalog of objects.

Example 29 includes the subject matter of any of Examples 25-28, wherein the modifying further comprises at least one of means for adjusting illumination of the masked segment, means for rotating the segmented object, and means for reshaping the segmented object.

Example 30 includes the subject matter of any of Examples 25-29, wherein the object recognition classifier is generated by a processor executed machine learning system based on a Convolutional Neural Network (CNN), a Random Forest Classifier or a Support Vector Machine (SVM).

Example 31 includes the subject matter of any of Examples 25-30, wherein the image of the scene is a 3D image.

Example 32 includes the subject matter of any of Examples 25-31, further comprising means for generating the 3D model of the object by employing a computer aided design (CAD) tool or a 3D scanning tool.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. A processor-implemented method for image manipulation, the method comprising:
rendering, by a processor, a plurality of image variations of an object based on a 3-Dimensional (3D) model of the object;
generating, by the processor, an object recognition classifier based on the rendered image variations;
recognizing, by the processor, the object from an image of a scene containing the object, the recognizing employing the generated object recognition classifier;
creating, by the processor, a mask to segment the recognized object from the image of the scene; and
modifying, by the processor, the masked segment of the image of the scene.

2. The method of claim 1, wherein the rendering further comprises at least one of, for each of the variations:
generating a background scene;
adjusting an orientation and translation of the object;
adjusting illumination of the object and of the background scene; and
adjusting visual effects of the object and of the background scene based on application of simulated camera parameters.

3. The method of claim 1, wherein the modifying further comprises replacing the segmented object with a second object.

4. The method of claim 3, wherein the second object is selected by a user from a catalog of objects.

5. The method of claim 1, wherein the modifying further comprises at least one of adjusting illumination of the masked segment, rotating the segmented object, and reshaping the segmented object.

6. The method of claim 1, wherein the object recognition classifier is generated by a processor executed machine learning system based on a Convolutional Neural Network (CNN), a Random Forest Classifier or a Support Vector Machine (SVM).

7. The method of claim 1, wherein the image of the scene is a 3D image.

8. The method of claim 1, further comprising generating the 3D model of the object by employing a computer aided design (CAD) tool or a 3D scanning tool.

9. A system for image manipulation, the system comprising:
an image rendering circuit to render a plurality of image variations of an object based on a 3-Dimensional (3D) model of the object;
a classifier generation circuit to generate an object recognition classifier based on the rendered image variations;
an object recognition circuit to recognize the object from an image of a scene containing the object, based on the generated object recognition classifier; and
an image modification circuit to create a mask to segment the recognized object from the image of the scene and modify the masked segment of the image of the scene.

10. The system of claim 9, wherein the image rendering circuit further comprises at least one of:
a background scene generator circuit to generate a background scene for each of the rendered image variations;
an image pose adjustment circuit to adjust an orientation and translation of the object for each of the rendered image variations; and
an illumination and visual effect adjustment circuit to adjust illumination of the object and of the background scene for each of the rendered image variations, and to further adjust visual effects of the object and of the background scene for each of the rendered image variations based on application of simulated camera parameters.

11. The system of claim 9, wherein the image modification circuit is further to replace the segmented object with a second object.

12. The system of claim 11, wherein the second object is selected by a user from a catalog of objects.

13. The system of claim 9, wherein the image modification circuit is further to perform at least one of adjusting illumination of the masked segment, rotating the segmented object, and reshaping the segmented object.

14. The system of claim 9, wherein the classifier generation circuit further comprises a machine learning system based on a Convolutional Neural Network (CNN), a Random Forest Classifier or a Support Vector Machine (SVM).

15. The system of claim 9, wherein the image of the scene is a 3D image.

16. The system of claim 9, wherein the 3D model of the object is generated by a computer aided design (CAD) tool or a 3D scanning tool.

17. At least one non-transitory computer readable storage medium having instructions encoded thereon that, when executed by one or more processors, result in the following operations for image manipulation, the operations comprising:
rendering a plurality of image variations of an object based on a 3-Dimensional (3D) model of the object;
generating an object recognition classifier based on the rendered image variations;
recognizing the object from an image of a scene containing the object, the recognizing employing the generated object recognition classifier;
creating a mask to segment the recognized object from the image of the scene; and
modifying the masked segment of the image of the scene.

18. The computer readable storage medium of claim 17, wherein the rendering further comprises at least one of, for each of the variations:
generating a background scene;
adjusting an orientation and translation of the object;
adjusting illumination of the object and of the background scene; and
adjusting visual effects of the object and of the background scene based on application of simulated camera parameters.

19. The computer readable storage medium of claim 17, wherein the modifying further comprises replacing the segmented object with a second object.

20. The computer readable storage medium of claim 19, wherein the second object is selected by a user from a catalog of objects.

21. The computer readable storage medium of claim 17, wherein the modifying further comprises at least one of adjusting illumination of the masked segment, rotating the segmented object, and reshaping the segmented object.

22. The computer readable storage medium of claim 17, wherein the object recognition classifier is generated by a processor executed machine learning system based on a Convolutional Neural Network (CNN), a Random Forest Classifier or a Support Vector Machine (SVM).

23. The computer readable storage medium of claim 17, wherein the image of the scene is a 3D image.

24. The computer readable storage medium of claim 17, further comprising generating the 3D model of the object by employing a computer aided design (CAD) tool or a 3D scanning tool.
